(19) United States
(12) Patent Application Publication
(10) Pub. No.: US 2015/0191950 A1
(43) Pub. Date: Jul. 9, 2015

(54) DISPENSER SECURITY DOOR

(71) Applicant: John BARTLEY, Inwood, WV (US)

(72) Inventor: John BARTLEY, Inwood, WV (US)

(21) Appl. No.: 14/147,055

(22) Filed: Jan. 3, 2014

(51) Int. Cl. E05C 19/08

(52) U.S. Cl. CPC E05C 19/08

(57) ABSTRACT

Exemplary embodiments of a product dispenser security door may be described. The product dispenser security door may be made from a variety of materials that are generally resilient to cutting or breaking on impact and may have attachment mechanisms on a first side and a second side of the door. A first side of the product dispenser security door may be coupled to a product dispenser using a plurality of hinges. A second side of the product dispenser security door may be coupled to a product dispenser using a plurality of padlock latches and a padlock, the shackle of which may be protected by a cover extending generally around the padlock latches and having a height sufficient to cover the shackle of a padlock.

### BACKGROUND

Product dispensers are widely used to dispense products to a customer. Typically, these dispensers have a container for a product (or a variety of products), a payment receptacle, and a door or cover used to cover the container and payment receptacle. Commonly, these dispensers are located in heavily trafficked areas, outdoors, or in other places where securing and monitoring a dispenser can be difficult or cost prohibitive.

Typically, product dispensers are made from a variety of materials that can be easily broken or otherwise punctured, such as glass, thin steel, or plastic. Products, coinage, paper money, and payment tokens can be easily stolen from these product dispensers, exposing the owner of a product dispenser to monetary losses for lost products, lost payments, and repairs to broken dispensers.

### SUMMARY

A product dispenser security door may be described. Exemplary embodiments of a product dispenser security door may have a frame, a cover coupled to the frame, a plurality of hinges, a plurality of padlock latches coupled to the frame and a product dispenser, and a padlock cover configured to cover the plurality of padlock latches. Exemplary embodiments may have solid or perforated covers coupled to the frame. Any number of sets of padlock latches, comprising at least one padlock latch coupled to the frame and at least one padlock latch coupled to a product dispenser and adjacent to the at least one padlock latch coupled to the frame, may be covered by a padlock cover configured to cover the shackle of an attached padlock such that cutting tools would not be able to be used to cut the shackle of an attached padlock.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1a shows an embodiment of a product dispenser door having a solid cover.

FIG. 1b shows an embodiment of a product dispenser door having an expanded or perforated cover.

FIG. 2 shows an exemplary embodiment of a product dispenser security door attached to a product dispenser using a plurality of hinges.

FIG. 3 shows an exemplary embodiment of the padlock latches and cover coupled to a product dispenser and the dispenser security door.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

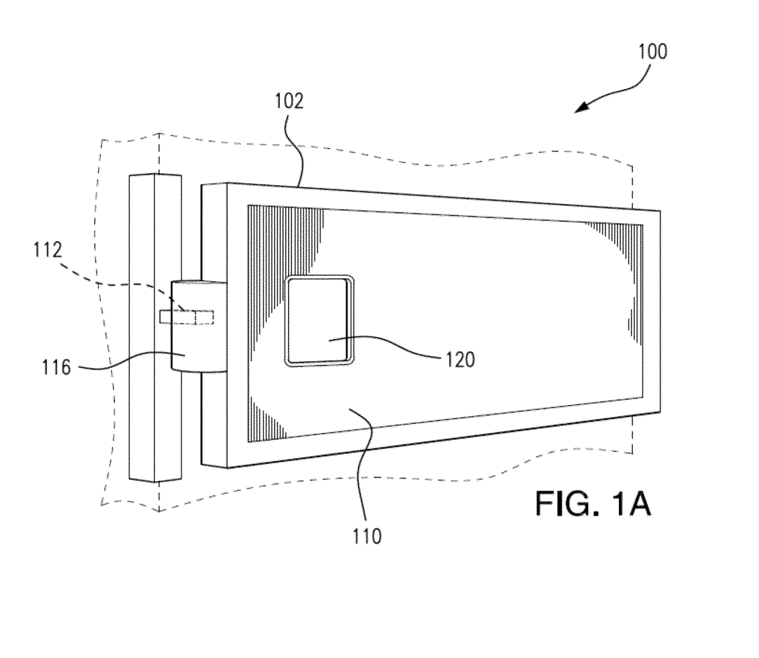

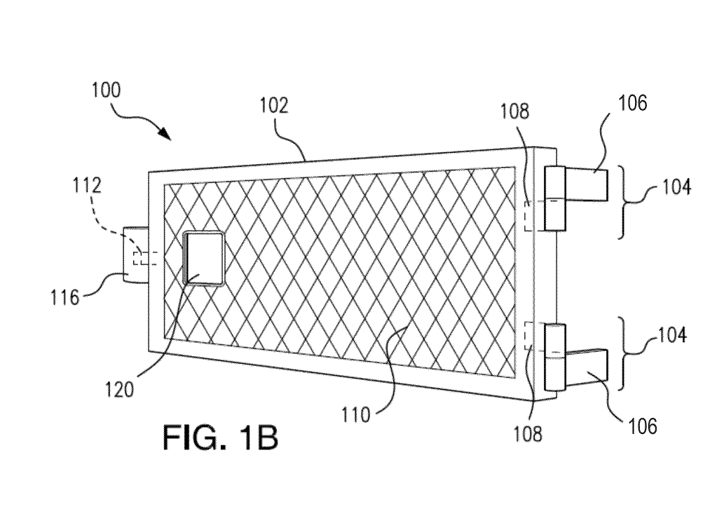

Referring generally to FIGS. 1-3, exemplary embodiments of a dispenser security door may be disclosed. A dispenser security door 100 may have a frame 102 having a first end and a second end, at least one hinge 104, a cover 110 having dimensions substantially similar to frame 102, at least one first padlock latch 112, at least one second padlock latch, and at least one padlock cover 116.

In some embodiments, dispenser security door 100 may be coupled to a product dispenser by coupling the first mounting plate 106 of each of the attached at least one hinge 104 to a first side of a product dispenser. The second mounting plate 108 of hinge 104 may be coupled to the first end of frame 102. Frame 102 may have at least one first padlock latch 112 coupled to a second side of a product dispenser, and at least one second padlock latch may be coupled to a second end of frame 102. One or more padlock covers 116 may be coupled to the second end of frame 102.

Referring generally to FIGS. 1a-1b, exemplary embodiments of a dispenser security door 100 may be disclosed. In some embodiments, as shown in FIG. 1a, cover 110 may be a solid plate coupled to frame 102. In other embodiments, as shown in FIG. 1b, cover 110 may be a sheet of expanded or perforated material coupled to frame 102. Cover 110 may have an aperture 120 to allow a customer to interact with a dispenser operating interface, for example a token insert. In some exemplary embodiments, aperture 120 may be sized appropriately to allow operation of a particular dispensing unit. In an embodiment, frame 102 and cover 110 may be welded together. In other embodiments, frame 102 and cover 110 may be coupled together using a high-strength adhesive, such as a resin-based epoxy, construction adhesives, or other appropriate adhesives as known in the art. In still further embodiments, frame 102 and cover 110 may be coupled together using a combination of an adhesive and one or more threaded fasteners; it may be appreciated that an adhesive can be used to lock a threaded fastener in a receptacle configured to accept said threaded fastener or that an adhesive can be separately used with threaded fasteners to couple frame 102 and cover 110 together. It may also be appreciated that any other type of coupling, as appropriate and known in the art, may be used to couple frame 102 and cover 110 together.

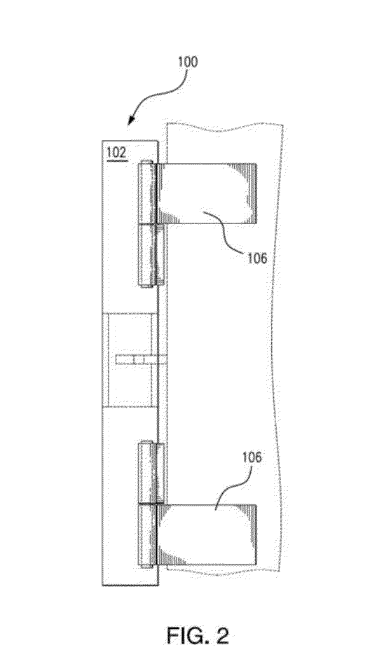

Referring now to FIG. 2, an exemplary embodiment of a dispenser security door 100 installed on a product dispenser may be disclosed. First mounting plate 106 may be coupled to a first side of a product dispenser. In some embodiments, there may be one first mounting plate 106 with at least one hinge attached thereto or disposed therefrom. In other embodiments, there may be multiple first mounting plates 106 that may each have one or more hinge attached thereto or disposed therefrom. In some embodiments, first mounting plate 106 may be welded to a product dispenser; in other embodiments, first mounting plate 106 may be coupled to a product dispenser using a high-strength adhesive, at least one threaded fastener, a combination of a threaded fastener and an adhesive, or any other coupling mechanism as would be reasonably understood by a person having ordinary skill in the art. In some embodiments using a threaded fastener, a carriage bolt type fastener may be used with the threads disposed inside a dispensing unit, so as to prevent unfastening of mounting plate 106 without access to the inside of the dispensing unit. Any other fastener as would be understood by a person having ordinary skill in the art and that may function in a similar manner may be used. Second mounting plate 108 may be coupled to a first end of frame 102 by welding second mounting plate 108 and frame 102 together; in other embodiments, second mounting plate 108 may be coupled to a first end of frame 102 using an adhesive, threaded fastener, a combination of a threaded fastener and an adhesive, or any other coupling mechanism as would be reasonably understood by a person having ordinary skill in the art. The at least one hinge 104 may movably couple mounting plate 106 and mounting plate 108. In some embodiments, each mounting plate may have a portion of the at least one hinge, allowing them to form a complete at least one hinge 104 when coupled. The at least one hinge may be of any hinge variety as would reasonably be understood by a person having ordinary skill in the art, including a pin and pipe hinge, a ball bearing hinge, a spring loaded hinge, a rising butt hinge, an H hinge, a pivot hinge, or a double action hinge.

In other embodiments of dispenser security door 100, a portion of an at least one hinge 104 may be disposed directly on frame 102 and a completing portion may be disposed on the at least one mounting plate 106. Mounting plate 106 may have one or more hinges or hinge portions disposed from or coupled to it, as may frame 102. In an exemplary embodiment, frame 102 may have two top portions of a rising butt hinge and mounting plate 106 may have two bottom portions of a rising butt hinge, allowing frame 102 to be hinged to mounting plate 106. In yet other embodiments, a portion of hinge 104 may be directly coupled to frame 102 and a counterpart portion of hinge 104 may be directly coupled to a product dispenser.

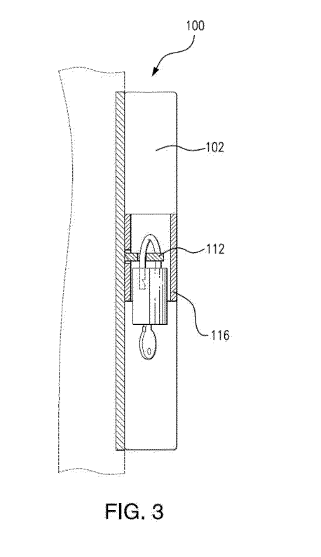

Referring now to FIG. 3, an exemplary embodiment of the first and second padlock latches and padlock cover may be disclosed. One or more sets of first padlock latches 112 and second padlock latches may be used to securably couple dispenser security door 100 to a product dispenser. A first padlock latch 112 may be coupled to or disposed from a product dispenser, while a second padlock latch may be coupled to or disposed from frame 102. The at least one first padlock latch 112 and at least one second padlock latch may be positioned such that when security door 100 is closed, the at least one first padlock latch 112 and at least one second padlock latch are adjacent to each other. A shackle of a padlock may be inserted through the at least one first padlock latch 112 and at least one second padlock latch to securably couple dispenser security door 100 to a product dispenser. One or more padlock covers 116 may be coupled to or disposed from frame 102 proximate the at least one first padlock latch. Padlock cover 116 may be substantially cylindrical and may surround a second padlock latch in a manner allowing a second padlock latch to interlock with a first padlock latch 112. Padlock cover 116 may be sized to allow a user to insert and remove a padlock into a set of at least one first padlock latch 112 and at least one padlock latch but prevent the use of bolt cutters or other cutting tools that may be used to break a padlock.

Alternatively, a second padlock latch is not required. Padlock cover 116 may have an aperture allowing a first padlock latch 112 to removably insert into cover 116 when security door 100 is in a closed position and consequently a second end of frame 102 is adjacent a second side of a product dispenser. When dispenser security door 100 is in a closed position and a padlock is inserted through an aperture in first padlock latch 112, it may prevent dispenser security door 100 from opening by preventing first padlock latch 112 from exiting the aperture in padlock cover 116.

Security door 100 may be configured to be generally resilient to impact and resistant to cutting. In some exemplary embodiments, the components of security door 100 may be made from a heavy gauge steel. In other embodiments, the components of security door 100 may be made from titanium or titanium alloys. In still further embodiments, the components of security door 100 may be made from aluminum alloys (for example, 6061 aluminum alloy, 7075 aluminum alloy, or aluminum-lithium alloys like Weldalite 049). It may be recognized, however, that the materials listed above are not limiting and may be substituted for by any appropriate material known in the art.

Cover 110, first padlock latches 112, second padlock latches, and padlock covers 116 may be configured to deter persons from breaking into a product dispenser protected by a security door 100. In some exemplary embodiments, cover 110 may have a thickness of between ¼ and ¾ inch; however, covers of any thickness are envisioned. First padlock latches 112 and second padlock latches may have a thickness of between ¼ and ⅜ inch; however, any thickness is envisioned, constrained by the length of the straight portion of the padlock shackle used to securably couple security door 100 to a product dispenser. Padlock cover 116 may have a thickness of between ¼ and ⅜ inch; however, padlock covers of any thickness are envisioned.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A security door for a product dispenser, comprising:
a frame having a first end and a second end;
one or more hinges;
a cover having dimensions substantially similar to the dimensions of the frame, coupled to the frame;
at least one padlock latch; and
at least one padlock cover coupled to the second end of the frame and configured to cover the at least one padlock latch and a shackle of a padlock engaged with the at least one padlock latch.

2. The security door of claim 1, further comprising at least one set of first and second padlock latches, wherein a first padlock latch is coupled to a product dispenser proximate a perimeter of the product dispenser and a second padlock latch coupled to the second end of the frame; and
at least one padlock cover coupled to the second end of the frame and configured to cover the at least one set of first and second padlock latches and a shackle of a padlock used to couple the first and second padlock latches together.

3. The security door of claim 1, wherein the at least one padlock cover has an aperture for receiving a padlock latch, which is coupled to a product dispenser proximate a perimeter of the product dispenser.

4. The security door of claim 1, further comprising at least one opening in the cover substantially the size of an operating interface of a product dispenser.

5. The security door of claim 1, wherein the one or more hinges have a first mounting plate and a second mounting plate, the first mounting plate being coupled to a product dispenser and the second mounting plate being coupled to the first end of the frame.

6. The security door of claim 1, wherein the one or more hinges are formed integrally with the first end of the frame, the one or more hinges have one or more mounting plates disposed from the portion of the one or more hinges in rotatable relation to the frame, and the one or more mounting plates may be coupled to a product dispenser.

7. The security door of claim 1, wherein the cover is welded to the frame.

8. The security door of claim 1, wherein the cover is coupled to the frame using a high-strength adhesive.

9. The security door of claim 1, wherein the cover is coupled to the frame using a combination of a high-strength adhesive and one or more threaded fasteners.

10. The security door of claim 1, wherein the cover is made from heavy gauge steel.

11. The security door of claim 1, wherein the cover is made from an aluminum alloy.

12. The security door of claim 1, wherein the cover is made from a titanium alloy.

13. The security door of claim 1, wherein the cover is a solid plate of material.

14. The security door of claim 1, wherein the cover is a sheet of expanded material.

15. The security door of claim 1, wherein the cover is a sheet of perforated material.

16. The security door of claim 1, wherein the frame is made from a heavy gauge steel.

17. The security door of claim 1, wherein the frame is made from an aluminum alloy.

18. The security door of claim 1, wherein the frame is made from a titanium alloy.
